(19) United States
(12) Patent Application Publication
(10) Pub. No.: US 2002/0039896 A1
(43) Pub. Date: Apr. 4, 2002

(54) Method and apparatus for disabling mobile telephones

(76) Inventor: Barry Allen Thomas Brown, Glasgow (GB)

Correspondence Address: HEWLETT-PACKARD COMPANY, Intellectual Property Administration, P.O. Box 272400, Fort Collins, CO, 80527-2400, US

(21) Appl. No.: 09/968,809

(22) Filed: Oct. 3, 2001

(30) Foreign Application Priority Data
Oct. 4, 2000 (GB) 0024231.3

(51) Int. Cl. H04M 3/00

(52) U.S. Cl. 455/419; 455/550; 455/414

(57) ABSTRACT

A system for disabling mobile telephones in circumstances where their use would prejudice the operation of critical systems (e.g. on an aeroplane, or in a hospital), or would irritate others includes a pair of RF beacons situated at the entrance to the controlled zone. The phone has receivers sensitive to the beacon outputs, and is adapted automatically to shut down into a standby state when passing in one direction through the beacons, and to re-activate when passing in the other direction.

### BACKGROUND TO THE INVENTION

1. Field of the Invention

The present invention relates to the control of the use of mobile telephones in particular environments where it is considered to be undesirable for such telephones to operate.

The widespread use of mobile telephones has been accompanied by a corresponding level of frustration and anger on the part of certain sections of the population over the use of mobile phones in circumstances which are considered to be either intrusive, dangerous, or disrespectful. Examples of such circumstances are in a hospital or on an aeroplane, where the operation of the phone could interfere with critical electronic systems, or in theatres, cinemas, or on public transport, where the use of a phone is considered by many to be an intrusion. While some phone users do not appear to be concerned with the sentiments of others, many phone users are sensitive to such sentiments, and indeed share them, but may on occasions forget to switch their phone off upon entering what might be termed a “phone free” zone.

2. Description of Related Art

The disabling of electronic equipment in hazardous areas is known from GB 2329794, and further disclosures in related areas include GB 2317302, EP 0880296, DE 19653845, JP 2000287274, JP 11007564 and JP 10174165.

### SUMMARY OF THE INVENTION

The present invention provides a system for disabling mobile phones in which the phone is automatically switched to a “standby” mode upon entering a phone controlled zone, thereby disabling the phone, and automatically switched from standby mode back to full operation upon leaving such a zone. According to a first aspect of the present invention, there is provided a method of disabling and enabling a mobile phone in a mobile phone controlled zone, comprising the steps of:

in the region of an entrance to the zone, transmitting to the phone a first wireless signature signal;

in response to the first wireless signature signal, automatically switching the phone from a fully operational mode to a standby mode, in which the phone is receptive only to a second wireless signature signal;

in the region of an exit to the zone, transmitting to the phone the second wireless signature signal;

in response to the second wireless signature signal automatically switching the phone from standby back to a fully operational mode; wherein

the first signature signal is provided by receipt of each of said distinct wireless signals in a first order, and the second signature signal is provided by receipt of said distinct wireless signals in an order opposite to the first order.

The signal which initiates disabling of the phone will preferably be transmitted prior to entering the controlled zone, and the signal enabling the phone once again will preferably be transmitted subsequent to leaving, although this is not essential, and as indicated above, the enabling and disabling may occur anywhere in the vicinity of the entrance and exit to a zone while providing the degree of protection from unwanted activation of a phone desired in a particular context.

In one embodiment of the present invention, the wireless signal has a wavelength which is only transmissible over short distances, thereby preventing overriding of the system by the reception of a second signature signal from a transmitter located remote from the phone controlled zone. Preferably the signal is a radio frequency signal in order to provide for the disabling of phones which are not in the line of sight with the transmitter(s) positioned at the entrances and exits of the controlled zone.

Given that the primary function of the wireless signature signals is to actuate operation of the phone upon entering and leaving the zone respectively, distinction between the first and second signature signals is only required by the handset when entering and leaving the zone. Thus the first and second signature signals could be provided by a pair of distinct rf signals (e.g. of differing frequency) and which are spaced apart in the direction of travel to and from the zone (typically by emission from two distinct rf beacons). The first signature signal would then be denoted by reception of the two signals in a first order (i.e. upon entering the zone), and the second signal by reception of the two signals in the opposite order to the first order (i.e. upon leaving the zone). This system has the advantage of simplicity.

Alternatively, two spatially distinct beacons could be provided which emit absolutely unique signals, the one providing the disable signature being located inside the entrance to the zone, the other, which provides the enable signature being located outside the entrance.

A further aspect of the present invention provides an apparatus for disabling a mobile phone in a phone controlled zone comprising:

transmitting means located at an entrance to the zone, and transmitting a first wireless signature signal to disable the mobile phone into a standby state and a second wireless signature signal to actuate the mobile phone from a standby state to a fully operational state;

at least one receiver provided on the mobile phone for receiving the first and second signature signals; wherein

the phone further comprises a decoder which decodes the signature signals and actuates operation of the phone accordingly.

### BRIEF DESCRIPTION OF DRAWINGS

Embodiments of the present invention will now be described, by way of example, and with reference to the accompanying drawings, in which:

FIG. 1 is a schematic representation of the boundary of a phone controlled zone in accordance with an embodiment of the present invention;

FIG. 2 is a circuit diagram; and

FIG. 3 is a schematic representation of the boundary of a phone controlled zone in accordance with a further embodiment of the present invention.

### DESCRIPTION OF PREFERRED EMBODIMENTS

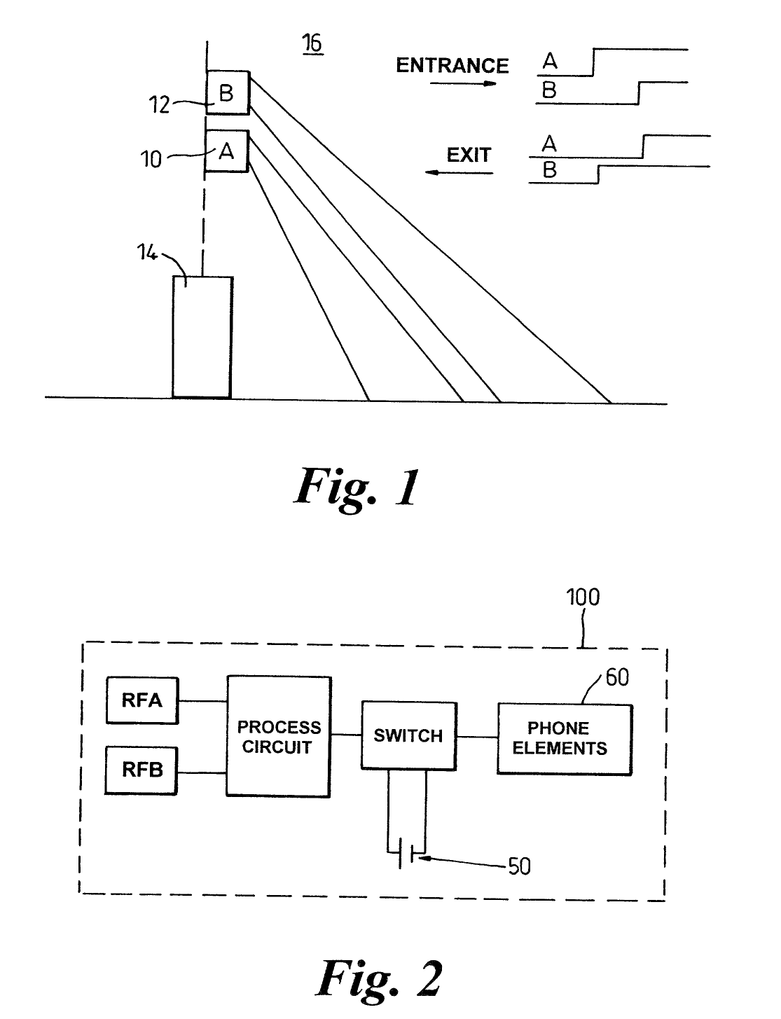

Referring now to FIG. 1, a pair of radio frequency beacons 10, 12 are located above the entrance 14 to a mobile phone controlled zone 16, in which it is either desirable (e.g. for social reasons), or critical for safety reasons that mobile phones do not operate. The beacons 10, 12 output RF signals A, B respectively, and the frequency of the signals A, B is chosen so that it will be different to that of the normal operation of the mobile phone, and also so they will not interfere with any critical electronic systems, whose operation disabling of a mobile phone is designed to safeguard. In addition, the frequency of the signals is chosen so that the transmission of identical signals from a remote location (for the purpose of overcoming the disabling of the phone within the zone) is difficult to achieve. Typically the frequency of the signals A, B will be in the region of 2.402-2.480 GHz, which is the frequency used in the “bluetooth” system.

As can be seen from FIG. 1, upon entering the zone, a phone user, and therefore the user's phone will pass first through the A signal beam, and then through the B signal beam. Upon leaving the zone, the phone will pass through the signal beams in reverse order, i.e. signal beam B followed by signal beam A. According to this embodiment of the invention, a mobile phone will be disabled to a standby mode by a disable signature, which in the present example has the form of signal A, followed a short time later by signal B, and enabled to full operation from standby mode by an enable signature, which in the present example has the form of a signal B followed a short time later by signal A. In a modification the two signals must be detected within a given time interval of each other.

Referring now additionally to FIG. 2, the phone 100 is provided with a pair of RF detection circuits RFA, RFB. Depending upon the nature of the RF output from the beacons 10, 12, the circuits RFA, RFB may be responsive to a variety of different types of RF signal. In the present example, the circuits could be adapted to detect a particular digital output. In a modification the circuits could be analogue, and responsive to, for example, a particular distinct frequency; any output from analogue detection circuits would need to be appropriately conditioned by the use of, inter alia, a suitable analogue to digital converter. The outputs of the detection circuits are passed to the inputs of a processing circuit 30, which is in turn connected to actuate a switch 40 that operates to supply power from a battery 50 to the known elements 60 of a the mobile phone 100 in order to enable normal operation thereof. The processing circuit 30 and switch 40 function in the manner outlined above. Specifically, in the event that an output is received from both detection circuits RFA, RFB, with the timing of the outputs indicating that the output of circuit RFA was activated shortly before the output of circuit RFB, this is indicative of the phone passing first through signal beam A, and then through signal beam B, and is the signature indicative of the phone is entering the controlled zone. The processing circuit 30 outputs a signal to the switch 40 causing it to cut power to the standard elements 60 of the phone (i.e. microwave transceiver etc.), thereby disabling the phone into a standby state, in which power is only supplied from the battery 50 to the detection circuits RFA, RFB, the processing circuit 30, and switch 40 (i.e. those elements whose operation is required in order to re-enable the phone). In the event that an output is received from both detection circuits RFA and RFB, with RFB being activated shortly before RFA, this is the signature indicative of the phone is passing out of the zone, and the processing circuitry 30 sends a signal to the switch 40 to cause it to supply power once again from the battery 50 to the phone elements.

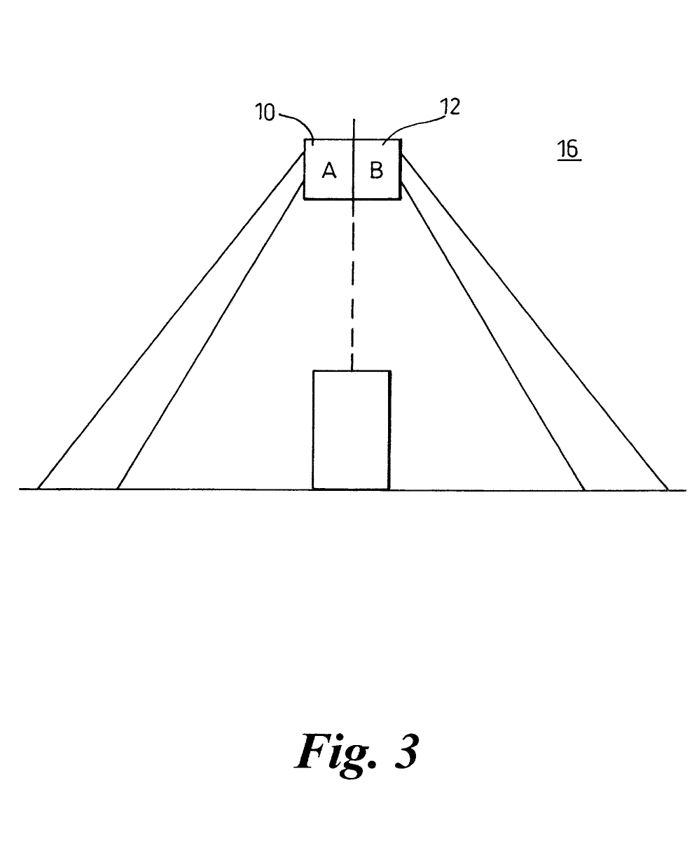

Referring now to FIG. 3, in an alternative embodiment, beacon 10 is located outside of the controlled zone, and beacon 12 inside the zone. In this embodiment, the processing circuit 30 is adapted to switch the phone on from standby if signal A is detected, and to switch the phone off to standby if signal B is detected. In this alternative, the processing circuit is configured to ignore signal A if the phone is already on, this being the likely situation when the phone is entering the controlled zone, and to ignore signal B if the phone is already off, this being the likely situation when the phone is leaving the controlled zone.

The present invention as described above provides a system according to which a phone is disabled when entering a phone-controlled zone without the consent of the user. It is envisaged that such a system is useful for circumstances where the use of a mobile telephone could be dangerous, e.g. on an aircraft, or in an hospital. However, it is equally possible to configure the system in such a manner that the disabling of a phone only takes place with the consent of the user. Alternatively, a combination of the two, in which disabling for safety considerations occurs without the consent of the user at one frequency and voluntary disabling at another.

It is not necessary to have two signals at differing frequencies to provide a signature signal; many other ways of producing appropriate distinct disabling and enabling signals may be used. For example the A and B beacons may emit distinct coded signals at the same carrier frequency.

1. A method of disabling and enabling a mobile phone in a mobile phone-controlled zone, comprising the steps of:
in the region of an entrance to the zone, transmitting to the phone a first wireless signal and then a second wireless signal;
in response to the first and second wireless signals, automatically disabling the phone from a fully operational mode to a standby mode, in which the phone is still receptive to the first and second wireless signals;
in the region of an exit to the zone, transmitting to the phone the second wireless signal and then the first wireless signal;
in response to the second and first wireless signals, automatically switching the phone from standby back to a fully operational mode.

2. A method according to claim 1 wherein the first and second wireless signals are of a frequency having a range which is too short to enable receipt within the zone of the second wireless signature when transmitted from outside the zone.

3. A method according to claim 1 wherein the first and second wireless signals are transmitted from a stationary source, and are received by the phone in a first order when entering the zone, and in a second order when leaving the zone.

4. A method according to claim 1 wherein the first and second signals are radio frequency signals.

5. A method according to claim 4 wherein the radio frequency signals have a frequency in excess of 2.4 GHz.

6. A method according to claim 1 wherein the first and second signals have different frequencies

7. A method according to claim 1 wherein the first and second signals are coded.

8. A system for enabling and disabling mobile phones in a phone controlled zone comprising:
transmitting means located in the region of an entrance to the zone, which transmits to the phone a first wireless signal and then a second wireless signal to disable the mobile phone into a standby state, and the second wireless signal then the first wireless signal to actuate the mobile phone from a standby state to a fully operational state;
receiving means provided on the mobile phone for receiving the first and second signals; wherein
the phone further comprises means for determining an order in which the first and second signals are received, and for actuating operation of the phone accordingly.

9. A system according to claim 8 wherein the transmitting means is stationary.

10. A system according to claim 9 wherein the transmitting means transmits first and second bluetooth signals.

11. A system according to claim 8 wherein the first and second signals are distinguished by different frequencies.

12. A system according to claim 8 wherein the first and second signals are distinguished by coding.

13. A system according to claim 8 wherein the transmitting means includes a first signal beacon transmitting the first wireless signal outside an entrance to the zone, and a second signal beacon transmitting a second wireless signal inside an entrance to the zone.
